(19) United States
(12) Patent Application Publication
(10) Pub. No.: US 2020/0380593 A1
(43) Pub. Date: Dec. 3, 2020

(54) Systems and Methods for Presenting and Responding to Visual Information and Ranking Results

(71) Applicant: Candi Renae Block, Reno, NV (US)

(72) Inventor: Candi Renae Block, Reno, NV (US)

(21) Appl. No.: 16/884,119

(22) Filed: May 27, 2020

Related U.S. Application Data
(60) Provisional application No. 62/853,126, filed on May 27, 2019.

(51) Int. Cl. G06Q 30/06; G06Q 30/02; G06F 3/0488

(52) U.S. Cl. CPC G06Q 30/0643; G06F 3/04883; G06Q 30/0282; G06Q 30/0625

(57) ABSTRACT

The present disclosure relates to systems and associated methods for presenting visual information to a user(s), having the user(s) respond to that information and presenting the user(s) with the associated results in a logical order, and in particular, responding to a merchant's visual offerings by a user reacting positively or negatively to various pictures with tactile or verbal actions and then the user being presented with ranked matches of the merchants based on a pre-chosen ranking scheme.

### CROSS REFERENCE TO RELATED APPLICATIONS

This patent application claims priority to U.S. Provisional Patent Application No. 62/853,126 filed on May 27, 2019, the entirety of which is incorporated herein fully by reference.

### FIELD OF THE DISCLOSURE

The present disclosure relates to systems and associated methods for presenting visual information to a user(s), having the user(s) respond to that information and presenting the user(s) with the associated results in a logical order, and in particular, responding to a merchant's visual offerings by a user reacting positively or negatively to various pictures with tactile or verbal actions and then the user being presented with ranked matches of the merchants based on a pre-chosen ranking scheme.

### BACKGROUND OF THE DISCLOSURE

In many instances, finding a compatible vendor/merchant or vendors/merchants that has the products or services one desires can be difficult. Using an internet search such as Google® can return many results which are not necessarily matched to visual representations of the company's products or services. In many instances, company's pay top dollar to have their SEO (search engine optimization) ranking higher than a competitor so that they can show up as early in the search results as possible which may not necessarily mean they are the best fit for the search being made. Also, it has been long understood that the number of users clicking on the second, third, fourth, etc., pages after performing an internet search is greatly reduced vs. the number of users searching and seeing the first page of results. For example, if a person desired to find a merchant who could provide services for flowers, in particular yellow roses, and they performed an internet search using the search term “flowers”, that search would yield a listing of flower shops initially based on the keyword, “flowers” and secondly based on the various flower shops' SEO rankings for that term “flowers”. The results themselves would not indicate to the user if any of the shops stocked yellow roses, nor would it indicate to the user if any shops specialized in yellow roses and lastly, it would not indicate to the user which shops currently had or didn't have yellow roses. Furthermore, if the keyword search term used was “yellow roses” for the search, the results would yield a mixture of companies that sold roses, but maybe not yellow, sold rose seed but again, maybe or maybe not yellow rose seed, and the search might even return a listing for yellow rose avenue, ‘yellow rose’ as the title of a song or yellow rose color paint. These examples are not exhaustive and simply illustrate the variance and randomness of internet searches.

Therefore, a need exists to allow users to find a merchant or merchants based upon visual information for that merchant, including but not limited to the merchant's exact offerings, and provide those results in a pre-determined ranked order.

Furthermore, it is an objective to address a problem rooted in technology, specifically, to address and remove SEO in order to achieve a user experience which allows for selection of vendors and companies which provide the best fit for the search being made.

### BRIEF SUMMARY OF THE DISCLOSURE

In accordance with embodiments of the present disclosure, systems for presenting and responding to visual information and returning the associated results in a logical order are provided that include a user being presented with a visual, the user attributing a negative response or a positive response to the given visual, the user then repeating the sequence enough times so that the ranking algorithm can properly attribute the positive and negative choices in order to logically present the ranked information to the user. The system could allow users to either verbally or tactilely respond to the visual in order to attribute the positive or negative connotation. The system can be configured to automatically filter out negative results, as the user progressed through the visuals, such that the visuals presented to the user nearer the end of the progression would most likely gain positive attribution. The system could also be configured to present all visuals, in a random order and then calculate the results when the user was finished looking at the visuals.

In some embodiments, the system could be an application or program on a computer or mobile device which could include a method for users to see various visual representations of products or services offered by various merchants. The user could choose or qualify, either verbally or through any other ordinarily recognized user input method, a positive or negative attribution to each visual presented. The visuals could be presented one at a time in linear random order or in blocks on the screen where many visuals were seen altogether on one screen. The user could attribute the positive or negative rating in many ways, such as a single-click or tap for positive and a double-click or double-tap for negative, swiping the entire visual in one direction for positive and in the opposite direction for negative, verbally identifying the visual and stating ‘yes’, ‘no’ or any other word or words which would indicate such positive or negative attribution or any other ordinary means of user input for a particular device. In a further embodiment, the user could attribute the positive or negative rating by clicking on the visual representation, such as an image, or by clicking on a button, wherein the button is located near or in connection with the visual representation. In yet another embodiment, the system could be configured to yield ranking results based on a subjective element such as the style of a particular visual. This method might require that each visual have an associated connection or tag of text/numbers or marking such that further attributes are available to the system when providing the results and ranking. An example of this, related to the above example search, might be a visual showing yellow roses and the associated text might have one or more tags, such as yellow, rose, yellow roses, 12, modern, altar flowers, etc.

Many other features and embodiments of the disclosure will be apparent from the accompanying drawing and from the following detailed description.

### BRIEF DESCRIPTION OF THE DRAWINGS

FIG. 1 illustrates the system according to one embodiment of the disclosure. Items connected via dashed lines indicate optional algorithm terms.

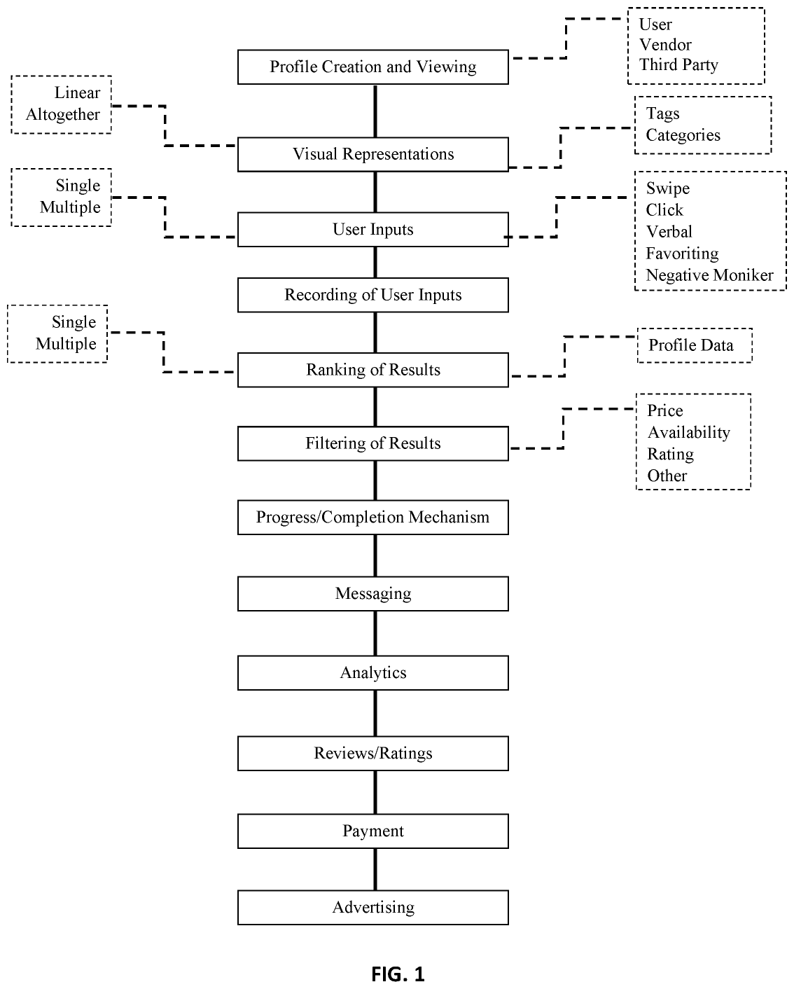

### DETAILED DESCRIPTION

In the following detailed description of the embodiments, reference is made to the accompanying drawing which forms a part hereof, and in which is shown by way of illustration a specific preferred embodiment in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosure. The following detailed description is, therefore, not to be taken in a limiting sense, and the scope of the present disclosure is defined only by the appended claims, along with the full scope of equivalents to which such claims are entitled.

In the exemplary embodiment, the system would be designed for the wedding industry in order to allow couples that are planning their wedding to search visually, and find, vendors/merchants based on the style or look of the products they offer or based on the style or look of the services they render. For example, if the users(s) were searching for a flower vendor, the system would allow users to see various visual representations, for example, pictures of flowers. These pictures would be visual representations of various vendors' offerings which could either be populated into the system by the vendor or read from a database populated by the system manager/owner. It is, of course, contemplated that the system of the disclosure could be applicable to a wide variety of service-based industries.

It should be noted that a visual representation, as used herein, can be a picture in any form including a 2D picture, 3D picture, 360-degree representation, video, drawing, graphic image or any blend or mix of these items. Also, in the exemplary embodiment, one picture of an item is anticipated. However, in other embodiments, a visual representation could be a group, collage, or visual listing of graphical or picture items, or any combination thereof, such that the function of choosing what is liked and not liked and the system yielding results is still maintained.

Each visual representation would have accompanying descriptive or identifying text tags and/or number tags. For example, a vendor named Bob's Flowers submitted their offering of yellow long-stem roses to the system by submitting a picture of yellow-long-stem roses. That picture would also contain text tags or number tags such as: Bob's Flowers, yellow, long-stem, classic, spring, $150, etc. Once the visual representations were compiled into the system's database, the visual representations would be presented one at a time to the user(s) randomly. The system could be configured to accept a proprietary file format such that the application could receive the visual representation, such as a picture, and the key words separately, input by the vendor/merchant or application manager and then combine the elements to form the proprietary format. Referring to the above example, as the user(s) viewed the various pictures from the various flower vendors/merchants, they would indicate for each picture, whether they liked or disliked that particular picture. For example, if the application was on a mobile device, the user could swipe left or right on each picture to indicate like or dislike. The system could be configured to have an easy to remember graphic, such as a green arrow pointing to the right and a red arrow pointing to the left to aid the user in their process. Of course, the system can be configured to use any method of user input and indication in order to allow the user to “mark’ the picture as one they like or dislike. As the user proceeds through the pictures, the application would log or record the user feedback and begin to apply a mathematical strategy (algorithm) of identifying, processing and ranking the various vendors associated with the pictures in order, from the pictures that were liked the most to ones that were liked the least. This methodology allows users to quickly browse and classify visual representations in order to find what they like best and ultimately, to find the vendor/merchant that corresponds to those visual representations. The system can also be configured through the mathematical strategy (algorithm) to process the results at the end of all of the selections or on the fly, in real time, as the user inputs their designations for each visual representation. In the latter case, mathematical processing can be finely tuned even more by yielding results internally and storing those results either in cache memory or in other memory, whether on the device or on a remote storage space such as a server in the cloud, and applying those results to the yet unseen visual representations. This process could happen each time the user(s) gives input for a visual representation. For example, if there were 10 vendors in a category and each vendor had 10 pictures submitted into the system, the user would begin to view the 100 pictures, randomly, one at a time. As the user(s) gave their input, one picture at a time, and after a minimum number of pictures was viewed to yield a mathematical average consistent with standard deviation and average calculations, the system could “look ahead” to the remaining pictures and begin to automatically eliminate, statistical negatives and only show statistical positives—pictures that will most likely be viewed positively by the user, given their previous selections. This real time processing after each user(s) input might yield different results vs. waiting until all of the pictures were viewed and then viewing the results but would give the user a relatively good result in a shorter amount of time. The processing might also yield different results after each input vs. the previous results. In other words, the more visual representations the user saw, the more accurate the results would be. Again, there are valid reasons for wanting both types of results and the system can be configured to allow for both.

As stated above, the system can be designed to have multiple categories. In the exemplary embodiment, an example of the categories could be, but not limited to:
Coordinators/planners
Venue
Caterer
Desserts
Drink/Bar Services
Photography
Videography
Photo booths
DJ
Rentals
Florists
Stationary
Calligraphy
Attire
Hair Stylists
Make-up Artists
Jewelry
Transportation
Officiants
Favors/Gifts
Lighting/Large installations

Of course, the list of categories provided above is merely a suggestion and the system can be designed with virtually no limit to the categories or vendors and pictures per category. As stated previously, the results can be viewed as a simple list of vendors from best to worst, or a filtering scheme can be used to arrange the results as desired by the user. An example of one such filtering scheme could be to filter the results by budget. The user could input a low and high range dollar amount, or they could choose from a list of ranges from a drop-down menu or any other filter type mechanism know to a person designing such search filtering mechanisms. The filters can be configured to correspond to inputs on the vendor/merchant profile or on the text/number tags on the visual representations. The filter would narrow the results as defined by the filter. In the exemplary embodiment, the system can be configured to have multiple filters such as, but not limited to:
if vendor has worked at their venue (stated in profile)
if vendor is within their budget (price range)
if vendor has their wedding date available
vendors' star rating from past clients
vendors' rating from fellow vendor reviews
if they offer gluten free/vegan menus (caterers/desserts only)

The preferred embodiment for the application would be mobile application software residing on a mobile platform, such as a smartphone or tablet and be downloadable from a standard location most mobile apps are downloaded from. It should be noted that the application can be any type of application including, but not limited to, a web application, a standard software application, a native mobile application (app) or a progressive web application (PWA) and can be implemented on traditional personal computers as well as mobile devices or in the cloud and simply pulled down to a user's browser. The software application would prompt a user to register on the application and complete an account and profile. The profile would allow users to fill out pertinent information in order for the application to determine and limit the scope of certain selections. For example, In the exemplary embodiment, the user profile can consist of the following:
Each User's Name
Contact Information
Wedding Date
Wedding City
Vendor Mile Radius Limitation
Venue (if known)
Preferred Style
Budget (range)
Number of Guests
Wedding Coordinator (if any)
Preferred Location, Outdoor or Indoor

Of course, this is merely a sampling of the data which can be included in the profile and it should be noted that profile information is not limited to the above list. The user profile could also prompt the user for their picture, payment information and any other information that would assist in the functionality of the application.

The mathematical algorithm used as described above can also be configured to use and integrate all or some of the user(s) profile information to calculate the results for the various categories. In the exemplary embodiment, for example, if a user's profile stated the wedding city as San Francisco, the vendors/merchants for the various categories could be limited, in this case, by the additional profile information of the Vendor Mile Radius limitation field which would restrict the available vendors/merchants to a certain number of miles from a GPS location somewhere in the city. The algorithm can be configured and programmed by someone skilled in the art to allow for a variety of locations for said GPS location. For example, if the user only wanted to see vendors/merchants within 20 miles of their city they could see that type of filtering with the system herein described. The system can also be configured to disable certain profile attributes if the user so desires.

As stated above the exemplary embodiment would allow users to choose various categories and see visual representations for vendor offerings in that category and once the user provided the necessary feedback as to “like” or “dislike” for the various visual representations, the system would yield results for the user as to vendors, ranked by the visual representations which were “liked” the most. The system could also be configured so that the contact information for the resulting list of vendors/merchant was available to the user(s) in the normal course, such as email link (which could open the user's email client and auto-populate the email address, a phone number which could be linked to opening the user's phone system on their device and either calling or texting the vendor. Furthermore, the system can have an in-application messaging system such that users within the same account can message each other. Further to messaging, the application can be configured such that vendors/merchants could message one another as well as vendors/merchants being able to message users. One normally skilled in the art of configuring such a software application can perform this task given current resources.

In the exemplary embodiment, as the user progressed through the available categories to the results, a method for user input could be implemented so as to mark the category completed once the user(s) reached the results stage of the process in a given category. It should be noted that as described earlier herein, “on the fly” results would not necessarily indicate that the user(s) was necessarily finished with a category or that they had completed that category. This “category completed” indication would then indicate, by a change of color, a graphical element such as check mark, or any other method that one skilled in the art might employ, that the category was completed. The system can also be configured to allow the user to un-mark the “completed” indication and start the process of selecting the visual representations again to find new resulting vendors/merchants and their resulting rank. It should be noted that with any embodiment herein stated, the system can be configured to “undo” the previous action such as, for example, a swipe for a “like” can be undone and re-swiped for “dislike”.

The system described herein can also be configured to allow for multiple users. In the exemplary embodiment for example, a couple getting married might not be together at the same time or in the same location when proceeding through a category and therefore may need to utilize the system at different times and in different places and on different devices. The system can be configured to allow simultaneous access through connection to Wi-Fi, Bluetooth, or any other known internet connection. In the exemplary embodiment, the system can be configured such that multiple users can be indicated in a user's profile and these “other” users can be given a method for login and choosing which user they are as they use the application. A user's profile could be configured for a field to indicate how many users will be using the application on the single given account. These users would have their own experience, whether at independent times or simultaneously, as stated previously. However, in the case of multiple users, the system can be configured to generate multiple results. For example, if the system were configured for 5 users, each user would have an individual result for each category as well as summed results when combining users. Also, the system can be configured to choose which users can be summed. For example, users 1, 3 and 5 could be chosen in the above example and their results would be summed together using the algorithm indicated earlier. In another example, a user could then change the chosen users, selecting 1, 2 and 3 and quickly yield new summed results. There is no limit to users and or choices in the above examples. Furthermore, the system can be configured to “pause and save” a user's choices and the progress location at which they are pausing. Accordingly, the user can login at another time and choose to resume the process where they left off. The system would be configured to allow partial progress through any number of categories or visual representation points.

Furthermore, the system can be configured such that no one vendor/merchant can gain an advantage over another vendor/merchant during the choosing of the visual representations by the user(s), and when the system yields the calculated final results so as to avoid the issue stated in the above background section whereas listings for typical internet searches rank higher than others because of “paid for” SEO rankings and/or paid advertising. Users will be able to trust that only their input as to their profile and their decisions regarding the visual presentations will yield the ranking of vendors/merchants when showing the results. Of course, it should be noted that in the case of multiple users the results will be modified as various user's results are combined and summed together.

In another embodiment of the present disclosure, the multiple user relationship could be one of master/slave such that one user is designated as the master and has the privileges and ability to functionally see the various visual representations and make the necessary indications of “like”/“dislike”. The other user(s) could be relegated to slave role in which they would have access to the account but would merely be spectators. The system would allow them to see results and individual choices but not allow them to input, edit or alter data or decisions made by the master user.

The system and algorithm described herein, can be further configured or improved to allow for “favoriting” certain visual representations giving them an “extra-like” status. This extra like can be incorporated into the mathematical calculations as so desired by the application owner and provide for increased weighting for the text or number tags associated with that particular image. Conversely, the system and algorithm can also be configured to provide for a user to apply a “negative” favoriting moniker to a visual representation which can also be incorporated into the mathematical calculations as so desired by the application owner and provide for decreased weighting for the text or number tags associated with that particular image. Along with this “favoriting” of images, the system could be further configured to allow for users to see their favorites in any category or in all categories so that they could edit the visual representation if so desired in order to change its status to another type, in other words, “favorite, “standard (no moniker), or “negative”. The system can be configured to allow multiple users to have their own favoriting process and can be combined with any of the elements herein described to further enhance the user experience. Furthermore, as the user(s) change their particular favorited visual representations from one classification to another, new results can be generated so that a user can quickly determine if classifying a particular visual representation in a certain way made a difference in determining the results.

In another embodiment, the system can be configured to provide a progress mechanism so as to indicate to the user the percentage of completion of visual representations or the number of visual representations finished/remaining of a category. The system could then be configured to report each categories percentage of completion or number of visual representations finished or remaining. This progress mechanism could be a progress bar, a percentage number or anything one skilled in the art would normally use when programing and configuring the system to employ such a progress mechanism.

In the exemplary embodiment, the system can be configured to include a vendor/merchant profile. One such possible configuration for the vendor/merchant profile could have both a public and private view such that users could see the public view and the system administrator or manager could see both the public and private view. The vendor/merchant profile can also be configured such that a vendor can upload or “install” their own visual representations along with a provided mechanism for attaching the text or number tags. This would allow for vendors/merchants to change visual representations as well as edit tags at their own desire. Some instances of fields in the exemplary embodiment of the vendor profile could include, but are not limited to:
Vendor Name
Contact Info
Minimum price for services
Blocked or reserved dates (dates they are not available)
Videos of their services
Pictures of their services
Customer Testimonials
Preferred or Favorite Style

The application can be further configured to all a full complement of analytics including but not limited to the ability for vendors/merchants to see their best performing visual representations, the total number of times each visual representations has been seen by a user(s) as well as how many times the visual representations have been swiped for ‘like’ or ‘dislike’. Furthermore, the analytics can include calculations such as yielding the number of times the vendor/merchant has been in the user(s) final results and what their average ranking was, the number of times the vendor/merchant profile was viewed and the number of times the user(s) used the contact scheme, as described above, to contact the vendor/merchant. Analytics for the user(s) can also be configured in the application. The application can be configured to show the users(s) all of the visual representations they have viewed, made a ‘like’ or dislike’ choice. These user(s) analytics can also be configured such that the user can make notes for each visual representation and save and edit those notes any time. The app can also be configured for the user to be able to further sort and categorize the visual representations into folders or other categorizing scheme, and within any scheme sorting functions such as sort by date, sort by category, sort by folder, sort alphabetically, sort by ‘like or ‘dislike’, etc. The application can also take these sorting features and present them in any manner so the user(s) can view the various sorted visual representations. One skilled in the art of configuring these sorts and the associated views can configure the application accordingly.

In yet another embodiment, the system can be configured to employ reviews from customers. These reviews and the type of labeling that can be used would be consistent with one skilled in the art and can employed in many different methods on the application. Furthermore, reviews found outside the application for vendors/merchants can be incorporated into the app, on the vendor/merchant public portion of their profile. These reviews might be, for example, from review sites such as Yelp, Google, Facebook, etc.

In yet another embodiment, a payment system can be configured such that the user, the vendor/merchant, or both the user and vendor/merchant could pay for access to services on the application. The payment portal can be configured such that one skilled in the art of implementing such payment systems can configure the application to accept standard forms of payment. Discount and Promo codes can be further implemented to enhance the user experience giving users traditional discounting to a vendor's/merchant's products and services on the application. Furthermore, the access to services can include a membership scheme or an a la carte payment scheme such that users or vendors/merchants could pay for usage of the application in its entirety or could pay for access to various categories. The application can also employ an advertising scheme in which the application can include advertising from various vendors/merchants, either paid for separately or together with the above-mentioned payment scheme.

In yet another embodiment, the system can be configured to allow for third party individuals of companies to utilize the application. For example, in the exemplary embodiment, a wedding coordinator account can be configured such that a couple might solicit the help of a wedding coordinator to perform the functions of the application and facilitate the contacting of the appropriate vendors/merchants. The system can allow for a user to put in their profile a wedding coordinator name such that the system would generate a separate login for the wedding coordinator so as to access the user's account. The wedding coordinator would be able to proceed through the categories, per the user's desires and result the vendors which they need to contact.

In another embodiment, the system herein can be configured to accept standard banner or other advertising from various networks such as, for example, AdMob™. To this end, the system could also be configured to allow a user to pay a premium to disable the advertising on the current software application or replace their current software application with an ad-free version.

The system could also be configured to have a rating system such that each user can rate the various vendors/merchants after services or products have been rendered. This rating system could be configured like many rating systems in existence possibly using various images such as 1-5 stars. One with ordinary skill in the art would understand the various review or rating schemes available in existence at the time of the disclosure and configure the system herein described to employ such a rating functionality.

While exemplary embodiments have been described herein, it is expressly noted that these embodiments should not be construed as limiting, but rather that additions and modifications to what is expressly described herein also are included within the scope of the disclosure. Moreover, it is to be understood that the features of the various embodiments described herein are not mutually exclusive and can exist in various combinations and permutations, even if such combinations or permutations are not made express herein, without departing from the spirit and scope of the disclosure.

What is claimed:

1. A system for presenting and responding to visual information and returning associated results in logical order, the system comprising:
providing to a user various visual representations of products or services offered by various merchants;
wherein the user can input or attribute a positive or negative rating to each visual presented.

2. The system of claim 1, wherein the visuals could be presented one at a time in linear random order.

3. The system of claim 1, wherein the visuals could be presented altogether on one screen.

4. The system of claim 1, wherein the user attributes the positive rating via a click.

5. The system of claim 1, wherein the user attributes the positive rating by swiping the entire visual in one direction and attributes the negative rating by swiping in the opposite direction.

6. The system of claim 1, wherein the system further comprises a recording of the input of a positive or negative attribution.

7. The system of claim 1, wherein the system is configured to yield ranking results based on a tag of text, numbers, or markings associated with the visual.

8. The system of claim 7, wherein multiple tags may be attributed to a visual.

9. The system of claim 7, wherein the tag is a vendor name.

10. The system of claim 7, wherein the system is configured to receive the visual and the tag separately.

11. The system of claim 7, wherein the system further comprises a recording of the input of a positive or negative attribution.

12. The system of claim 7, wherein the system further comprises applying a mathematical strategy of identifying, processing, and ranking the tags and developing a user output for viewing of the ranking.

13. The system of claim 9, wherein the system further comprises applying a mathematical strategy of identifying, processing, and ranking the vendor tag and developing a user output for viewing of the ranking.

14. The system of claim 7, wherein the ranking can be filtered to arrange the results as desired by the user.

15. The system of claim 1, wherein the visual representations are grouped into categories.

16. The system of claim 1, wherein the system allows for multiple users.

17. The system of claim 16, wherein multiple users' inputs can be summed by applying a mathematical strategy of identifying, processing, and ranking a tag associated with the visual and developing a user output for viewing of the ranking.

18. The system of claim 1, wherein the system is configured so that no one vendor can gain an advantage over another vendor.

19. The system of claim 1, wherein the system is configured to provide for user and vendor profiles.

20. The system of claim 1, wherein the system is configured to remove search engine optimization.
